(19) United States
(12) Patent Application Publication
(10) Pub. No.: US 2010/0095537 A1
(43) Pub. Date: Apr. 22, 2010

(54) TOOL AND METHOD OF USING SAME

(76) Inventors: David P. Serdynski, Waukesha, WI (US); David B. Griep, Rubicon, WI (US); Troy C. Thorson, Waukesha, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/644,797

(22) Filed: Dec. 22, 2009

Related U.S. Application Data
(63) Continuation of application No. 11/537,485, filed on Sep. 29, 2006, now abandoned.
(60) Provisional application No. 60/722,824, filed on Sep. 30, 2005.

(51) Int. Cl. B23D 49/16; B25F 5/02

(52) U.S. Cl. 30/392; 30/517

(57) ABSTRACT

The invention relates to a reciprocating saw that includes a reciprocatable spindle for supporting a saw blade for reciprocating sawing movement. A body houses a motor and a drive mechanism driven by the motor. The drive mechanism selectively drives the spindle and the body supports the spindle. A grip extends outwardly from the body adjacent a center of gravity of the saw so as to allow an operator to operate the reciprocating saw with a first hand and support a workpiece being cut with a second hand.

This application is a continuation of prior-filed, co-pending U.S. patent application Ser. No. 11/537,485, filed Sep. 29, 2006, which claims the benefit of U.S. Provisional Patent Application No. 60/722,824, filed Sep. 30, 2005, the entire contents of which are all hereby incorporated by reference.

### FIELD OF THE INVENTION

The present invention relates to power tools and, more particularly, to a handle arrangement for a power tool, such as a reciprocating saw.

### SUMMARY

Typically, power tools, such as reciprocating saws, have a handle which is not located at or even near the tool's center of gravity. For example, in a reciprocating saw, the main handle is at the far end of the saw body away from the saw blade. One-handed cutting (e.g., to allow the free hand to manipulate or stabilize the workpiece) puts great strain on an operator's hand and/or arm.

In some embodiments, the present invention provides a reciprocating saw which may allow an operator to operate the saw one-handed to allow a free hand to manipulate or stabilize a workpiece, support the operator, etc.

In some embodiments, a one-handed reciprocating saw may be provided. In some embodiments, a reciprocating saw may include a top handle. Arm engagement portions may also be provided.

In some embodiments, the invention provides a reciprocating saw including a reciprocatable spindle for supporting a saw blade for reciprocating sawing movement, a body housing a motor and a drive mechanism driven by the motor, the drive mechanism selectively driving the spindle, the body supporting the spindle, and a grip extending outwardly from the body proximate a center of gravity of the saw so as to allow an operator to operate the reciprocating saw with a first hand and support a workpiece being cut with a second hand.

In other embodiments, the invention provides a reciprocating saw including a reciprocatable spindle for supporting a saw blade for reciprocating sawing movement, a body housing a motor and a drive mechanism driven by the motor, the drive mechanism selectively driving the spindle, the body supporting the spindle, and a grip extending outwardly from an upper surface of the body.

In yet other embodiments, the invention provides a method of operating a reciprocating saw. The reciprocating saw can include a spindle and a body housing a motor and a drive mechanism driven by the motor, the drive mechanism selectively driving the spindle, and a grip extending outwardly from the body. The method can include the acts of providing a switch assembly supported on the grip and being operable to electrically connect the motor to a power source, engaging the grip with a hand of an operator proximate a center of gravity of the saw, operating the switch assembly with the hand while the hand engages the grip, and operating the switch assembly and the motor to cause reciprocating sawing movement of the spindle.

Other aspects of the invention will become apparent to those skilled in the art upon review of the following detailed description and accompanying drawings.

### BRIEF DESCRIPTION OF THE DRAWINGS

In the drawings, wherein like reference numerals indicate like parts.

FIG. 1 is a front perspective view of a power tool, such as a reciprocating saw.

FIG. 2 is a top view of the power tool shown in FIG. 1.

FIG. 3 is a bottom view of the power tool shown in FIG. 1.

FIG. 4 is a left side view of the power tool shown in FIG. 1.

FIG. 5 is a rear view of the power tool shown in FIG. 1.

FIG. 6 is a front view of the power tool shown in FIG. 1.

FIG. 7 is a perspective view of a battery pack for use with the power tool shown in FIG. 1.

FIG. 8 is an exploded side view of the power tool shown in FIG. 1 and the battery pack shown in FIG. 7.

FIG. 9 is a side view of a saw blade for use with the power tool shown in FIG. 1.

### DETAILED DESCRIPTION

Before any independent features and at least one embodiment of the invention is explained in detail, it is to be understood that the invention is not limited in its application to the details of the embodiment and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

Although references are made below to directions, such as left, right, up, down, top, bottom, front, rear, forward, back, etc., in describing the drawings, the references are made relative to the drawings (as normally viewed) for convenience. These directions are not intended to be taken literally or to limit the present invention in any form. In addition, terms such as “first” and “second” are used herein for purposes of description and are not intended to indicate or imply relative importance or significance.

The use of “including”, “having”, and “comprising” and variations thereof herein is meant to encompass the items listed thereafter and equivalents thereof as well as additional items.

A power tool 10, such as, for example, a saw, a reciprocating saw, etc., is illustrated in the drawings. Independent aspects of the illustrated power tool may be incorporated in other power tools, such as, for example, drills, rotary hammers, etc.

In the illustrated embodiment, the power tool 10 generally includes a housing assembly or body 12 having a motor housing 14 and a gear case 18. In the motor housing 14, the body 12 houses a motor 16 and, in the gear case 18, the body 12 houses a drive mechanism 20 drivingly connected to the motor 16. While in the illustrated embodiment, the body 12 houses both the motor 16 and the drive mechanism 20, in other embodiments (not shown), the body 12 houses only one or at least one of the motor 16 and the drive mechanism 20.

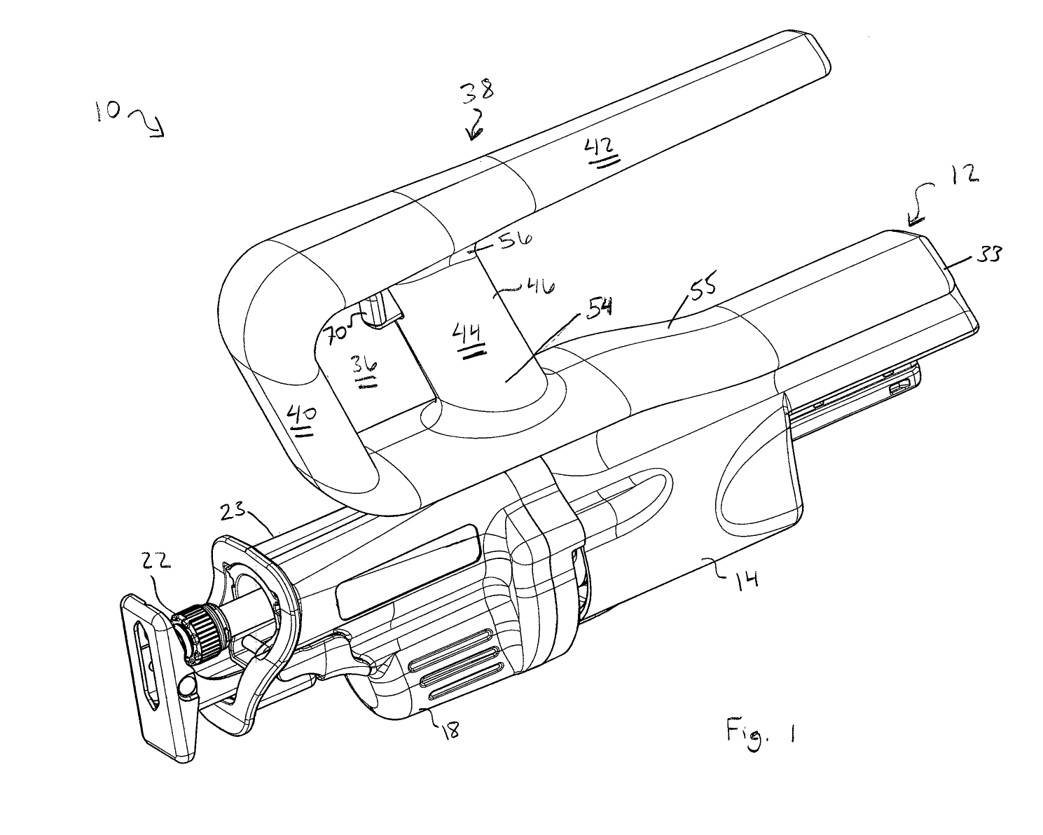

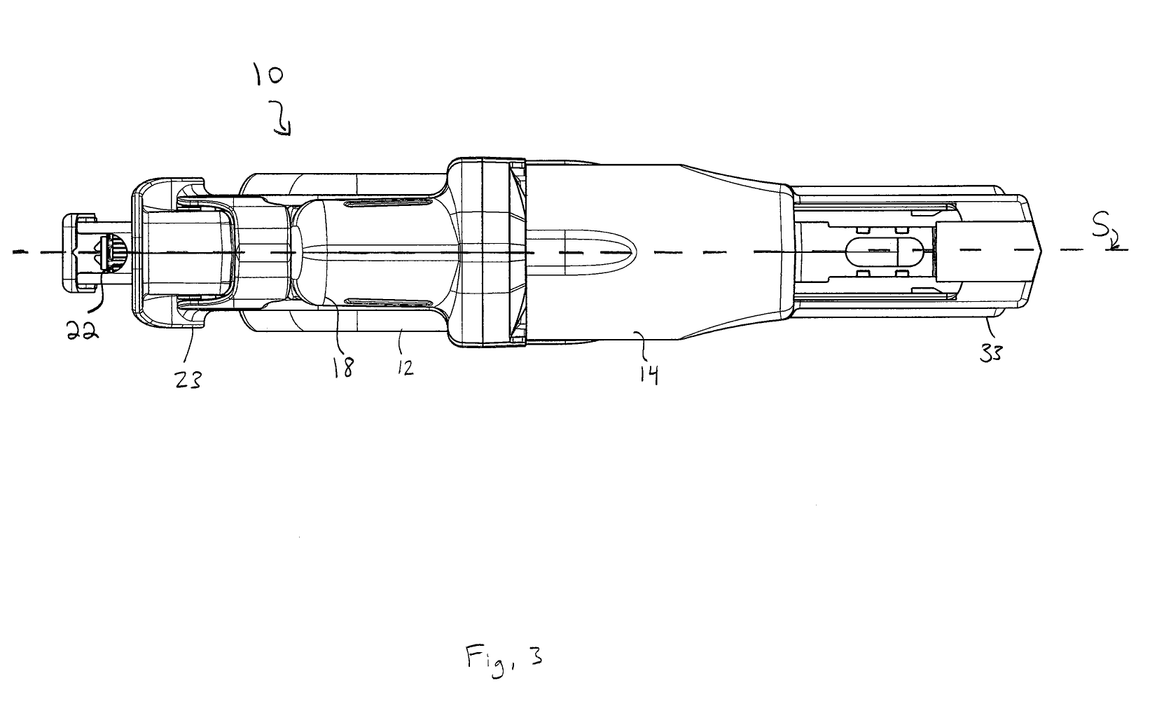

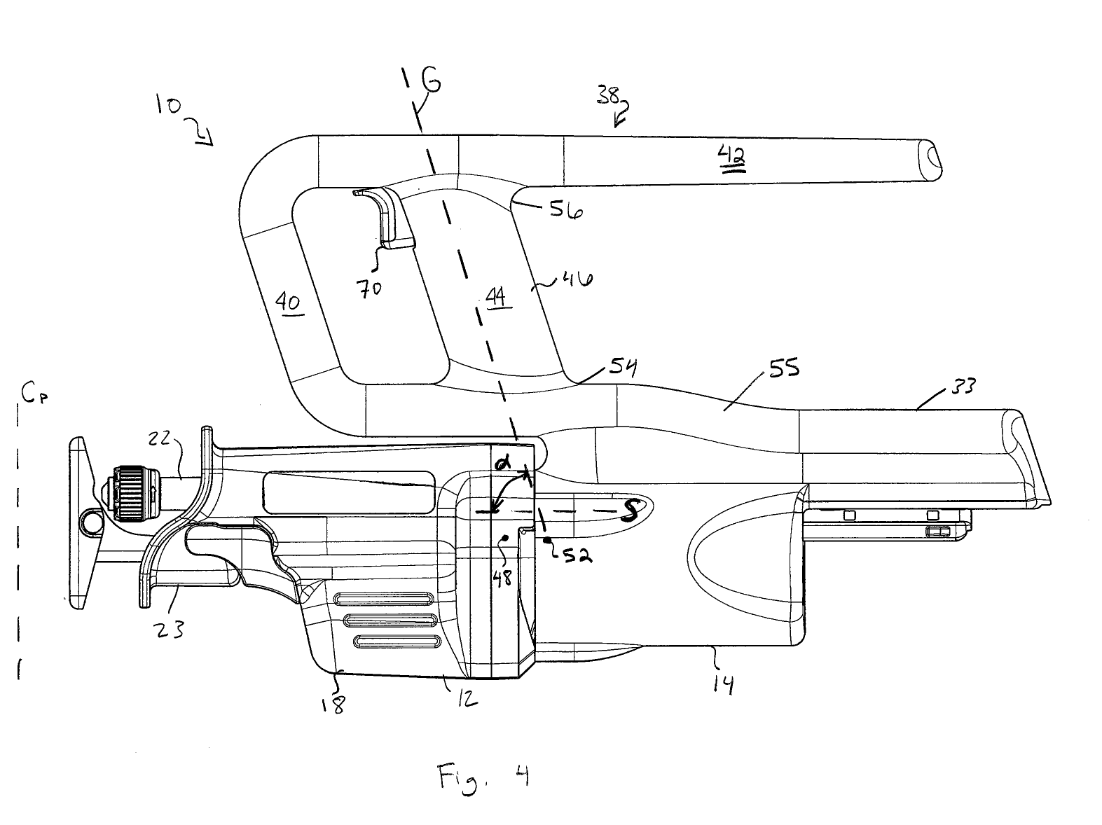

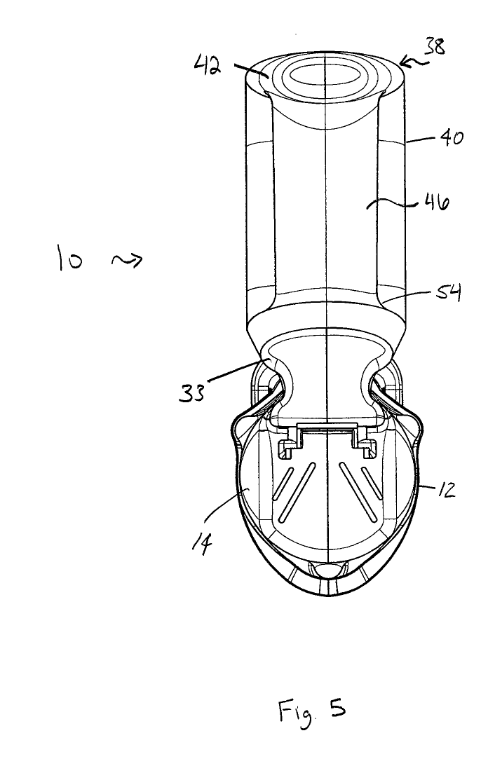

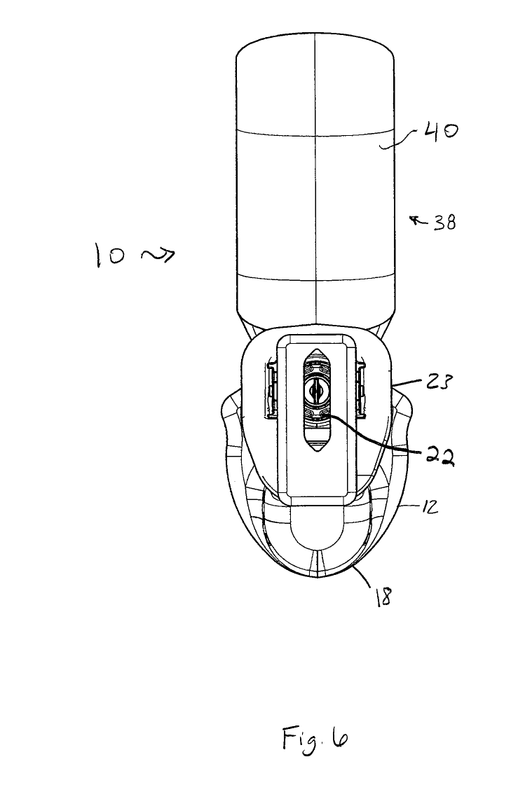

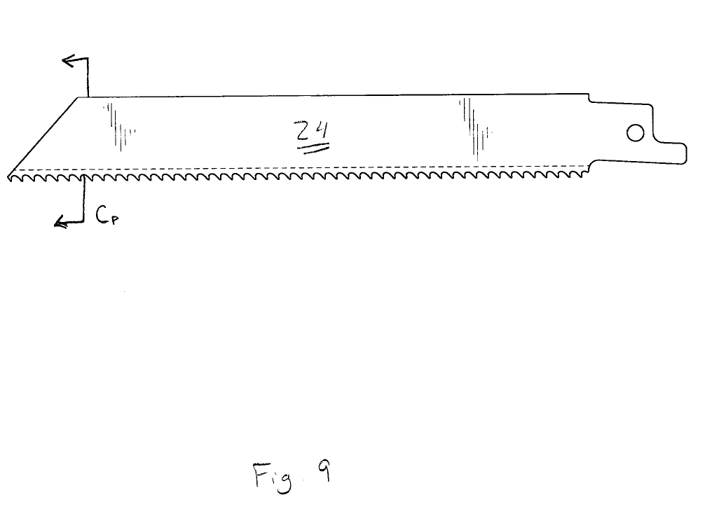

The motor 16 is operable to drive the drive mechanism 20 to reciprocate a spindle 22 generally along a spindle axis S (shown in FIG. 3). In the illustrated embodiment of FIGS. 1-8, the spindle 22 is supported by the forward end 23 of the body 12 for reciprocating motion and may be supported for rocking motion or orbital motion relative to the body 12. In the illustrated embodiment, the spindle 22 is adapted to support a tool element, such as a saw blade 24 for cutting a workpiece (not shown) in a cutting plane C_{P} defined by the saw blade 24 (shown in FIGS. 4 and 9).

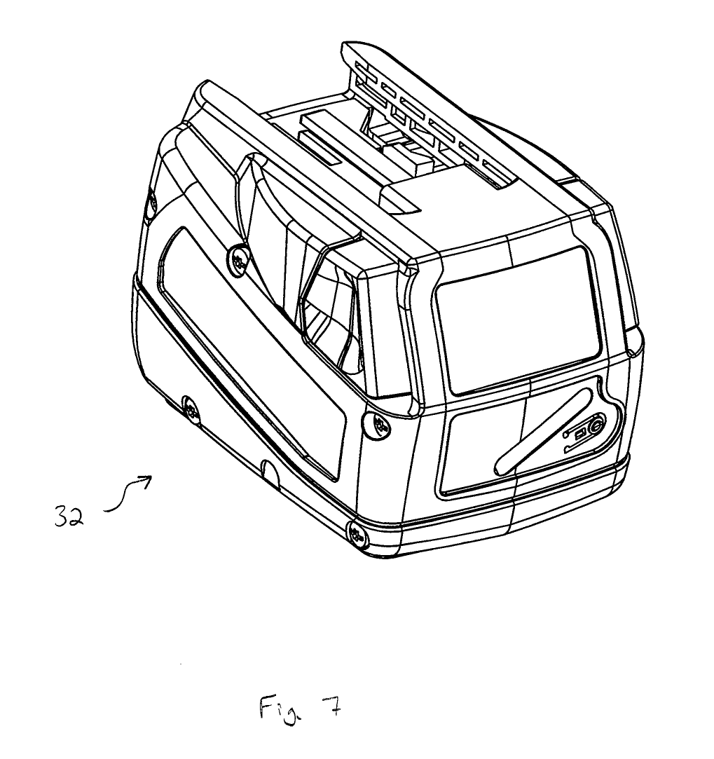

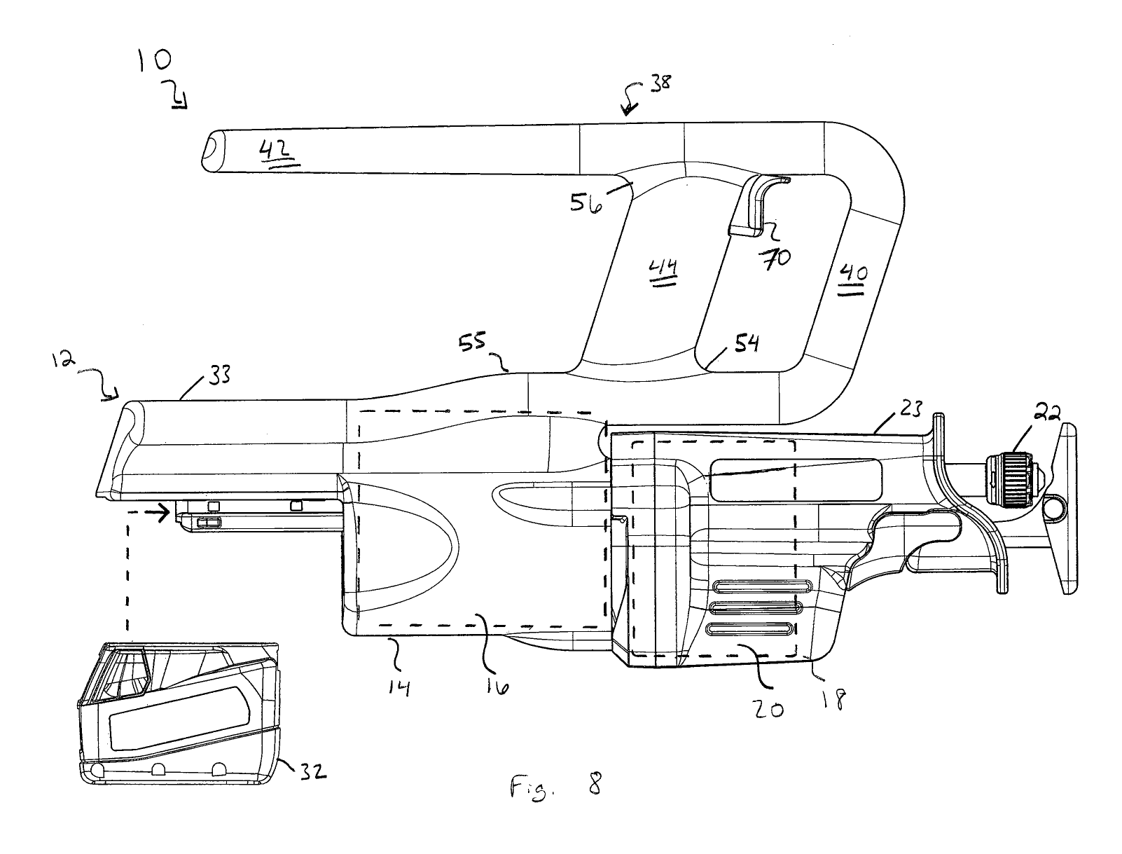

The motor 16 can be an electric motor that is connectable to a power source, such as, for example, to a battery pack 32 supported on a rearward portion of the body 12 adjacent a rearward end 33 of the body 12 or on a rearward portion of a handle assembly 38 (shown in FIGS. 7 and 8). In other embodiments, the motor 16 can be connectable to a separate AC or DC power source by a plug. An electric circuit (not shown) is operable to connect the motor 16 to the battery pack 32.

In some embodiments, the tool 10 can be a one-handed reciprocating saw which is operated and controlled by a single hand of an operator so that the operator can support a workpiece being cut with a second hand. In some independent aspects and in the illustrated embodiment, the tool 10 can be a top handle reciprocating saw.

In the illustrated embodiment, the tool 10 includes a handle assembly 38 having a grip portion 44 which is positioned proximate the center of gravity of the tool 48 between the forward and rearward ends 23, 33 of the body 12. In other embodiments, the grip portion 44 can be positioned toward the center of gravity of the combined tool and battery pack 52 so that the tool 10 and battery pack 32 are balanced during operation of the tool 10.

In some embodiments, the handle assembly 38 is oriented so that the center of gravity of the tool 48 is forward of a grip axis G, causing a moment about the grip axis G such that the weight of the tool 10 generates a downward force along the cutting plane C_{P} of the saw blade 24. This downward force helps keep the tool 10 engaged with the workpiece and helps the operator cut the workpiece because both the operator and the moment of the tool 10 are pressing the tool 10 against the workpiece.

In the illustrated embodiment, the grip portion 44 is positioned above the body 12 of the tool 10 and is a D-shaped handle adapted to be gripped relatively comfortably and securely by one of the operator's hands. In other embodiments (not shown), the grip portion 44 may be below the body 12 of the tool 10 (such as in a T-Handle drill) and/or may be provided on the body 12 of the tool 10 (such as in a router having a grip on the motor housing or base) and may have other shapes and configurations.

As show in FIGS. 1-8, in some embodiments, a cushion grip 46 is integrally formed on the grip portion 44, making the grip portion 44 relatively more comfortable for the operator to hold. In some embodiments, the cushion grip 46 of the grip portion 44 can be formed of an elastomeric material and can be operable to absorb vibrations generated during operation of the tool 10.

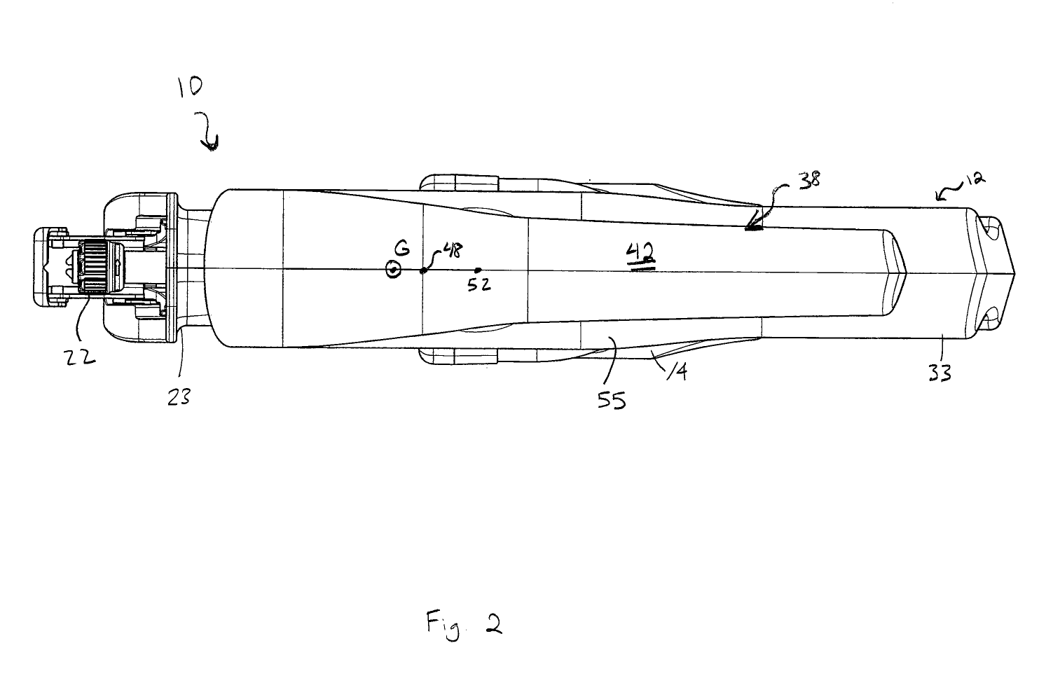

In the illustrated embodiment of FIGS. 1-8, the grip portion 44 includes a first portion 54 connected to an upper surface 55 of the tool body 12 and a second portion 56 extending away from the tool body 12. The grip portion 44 can also define a grip axis G between the first and second portions 54, 56, respectively, shown in FIGS. 2 and 4.

In some embodiments, such as the illustrated embodiment of FIGS. 1-8, the grip axis G and the spindle axis S define a non-perpendicular angle a of between about 60 degrees and about 90 degrees (see FIG. 4). In other embodiments, the orientation of the grip axis G and spindle axis S may be different, such as generally perpendicular or skew. As shown in FIGS. 1-8, the grip axis G is generally parallel to the cutting plane C_{P} defined by the saw blade 24 (see specifically FIGS. 4 and 9). In other embodiments, the orientations of the grip axis G and the saw blade 24 or cutting plane C_{P} may be different, such as generally perpendicular or skew.

In some embodiments, the grip portion 44 can be oriented so that the grip axis G is substantially aligned with the center of gravity of the tool 48. In other embodiments, the grip portion 44 can be oriented so that the grip axis G is substantially aligned with the center of gravity of the combination of the tool and the battery pack 52. In still other embodiments, the grip portion 44 can be oriented so that the grip axis G extends between the center of gravity of the tool 48 and the center of gravity of the combination of the tool and the battery pack 52, or alternatively, the grip portion 44 can be oriented so that the grip axis G is adjacent to one of the center of gravity of the tool 48 and the center of gravity of the combination of the tool and the battery pack 52.

The handle assembly 38 may provide additional portions to increase engagement with an operator's arm (e.g., to prevent the operator's hand/wrist from bearing the full weight of the tool and the battery during one handed use) and may “cradle” the operator's arm in a comfortable operating position.

In the illustrated embodiment, the handle assembly 38 also includes a cantilever arm 42 to provide increased engagement between the tool 10 and the operator's hand and arm (e.g., contact points with the forearm). The handle assembly 38 may include lateral arm engagement portions (not shown) to provide lateral engagement with the operator's hand and/or arm. A tightening portion (not shown), such as, for example, a strap, band, etc., may be provided to bring the arm engagement portion(s) into closer engagement with the operator's hand and/or arm (e.g., to fit to any given operator's body size). In other embodiments, the handle assembly 38 and/or portions of the handle assembly 38 may be adjustable to more closely engage an operator's hand or arm (e.g., to fit to any given operator's body size).

In the illustrated embodiment, forward structure or guard 40 is provided in front of the grip portion 44. The forward structure may provide a guard 40 to prevent engagement of the operator's hand and/or arm with objects in the work area (e.g., the tool element, the workpiece, debris, etc.).

In some embodiments (not shown), the handle assembly 38 may include a glove portion formed of a material which may be one or more of soft, cushioned, breathable, etc. Rigid members may be formed in the glove portion to provide the cantilever, the lateral support, the forward structure, etc.

In the illustrated embodiment, an on/off switch 70 is provided on the grip portion 44 for actuation by the operator's hand which is holding the grip portion 44. The switch 70 can be connected along an electrical circuit between the motor 16 and the battery pack 32 and can be operable to selectively connect the motor 16 to the battery pack 32. In other embodiments (not shown), the switch 70 may be positioned on another portion of the tool 10 (e.g., the battery support, the motor housing, etc.) to be operated by the operator's other hand.

As shown in FIGS. 1-8, the grip portion 44 defines an opening 36 for an operator's fingers and the on/off switch 70 includes a trigger and a plunger (not shown) extending between the trigger and the on/off switch 70. The on/off switch, trigger and plunger form a switch assembly. The trigger extends outwardly through an opening in the grip portion 44 for engagement by an operator's finger. In some embodiments, the trigger extends outwardly through an opening in the grip portion 44 for engagement by two or more of the operator's fingers. In these embodiments, the trigger is relatively elongated in a direction substantially parallel to the grip axis G.

In some embodiments, such as the illustrated embodiment of FIGS. 1-8, a substantial portion of the mass of the tool 10 is centered in or near the gear case 18 and the switch 70 or at least a portion of the switch 70 is supported on the hand grip portion 44 adjacent to the gear case 18 so that an operator can operate the switch 70 and support the tool 10 with a single hand.

In the illustrated embodiment of FIGS. 1-8, the on/off switch 70 is a variable speed switch, which, as the trigger and the plunger (not shown) is moved rearwardly from an extended position toward a depressed position, supplies gradually increasing power from the battery pack 32 to the motor 16. During operation of the tool 10, an operator wraps his hand at least partially around the grip portion 44 and inserts one or more fingers into the opening 36 to squeeze the trigger with one or more fingers to move the trigger and the plunger from the extended position toward a depressed or recessed position to operate the motor 16.

Additional switch assemblies (e.g., speed control, saw blade path control (straight, orbital, rocker, etc.), transmission, etc.) may be provided on or near the grip portion 44 for actuation by the operator's single hand. Such additional switch assemblies (not shown) can also or alternatively be connected to the electrical circuit between the battery pack 32 and the motor 16. In other embodiments, one or more of such additional switch assemblies may be positioned on another portion of the tool 10 (e.g., the battery support, the motor housing 14, etc.).

As shown in FIGS. 1-8, the guard 40 can extend across at least a portion of the on/off switch 70 to protect the on/off switch 70 and an operator's hand during operation of the tool 10. In some such embodiments, the guard 40 can also or alternatively prevent inadvertent activation of the tool 10 by preventing the workpiece or other objects in the work area from contacting the on/off switch 70.

In the illustrated embodiment, the handle assembly 38 is connected to or formed with at least a portion of the housing assembly 12 (supporting the motor 16 and/or the drive mechanism). Flexible structure (not shown) may be provided between the handle assembly 38 and the body 12 to, for example, reduce the transmission of vibration, impacts, etc., to the operator. The flexible structure may be provided by the material of the handle assembly 38 and/or by separate material/structure between the handle assembly 38 and the body 12. Such additional material can include elastomeric materials and/or one or more biasing elements or springs.

In other embodiments (not shown), the reciprocating saw may have a handle assembly 38 which is movable relative to the motor 16, relative to the drive mechanism 20 and/or relative to the saw blade 24.

Such a handle assembly 38 may be a pivotable handle portion (e.g., pivotable about an axis generally perpendicular to the axis of the body 12) constructed in a manner similar to the handle portion illustrated in U.S. patent application Ser. No. 09/704,914, filed Nov. 2, 2000; and Ser. No. 10/796,365, filed Mar. 9, 2004; the entire contents of which are hereby incorporated by reference.

Such a handle assembly 38 may be a rotatable handle assembly (e.g., pivotable about an axis generally parallel to or the same as the axis of the body 12) constructed in a manner similar to that disclosed U.S. Pat. No. 6,912,790, issued Jul. 5, 2005; and in U.S. patent application Ser. No. 11/145,751, filed Jun. 6, 2005; the entire contents of which are hereby incorporated by reference.

In some embodiments (not shown), the handle assembly 38 may be movable relative to the motor 16 and/or relative to the drive mechanism 20 in another manner. For example, the handle assembly 38 may be slidable to extend and/or reduce the length of the tool 10 (from the rearmost portion of the tool 10 to the forward most portion of the tool 10).

In some embodiments (not shown), the handle assembly 38 may have movement in more than one manner (e.g., combination pivotable, rotatable and/or slidable).

In embodiments with a movable handle, the tool 10 may include a locking assembly (not shown) for locking the handle assembly 38 in a position relative to the motor 16 and/or relative to the drive mechanism 20. The locking assembly may include an actuator for operating the locking assembly (e.g., unlocking and/or locking). The actuator may be located on the handle assembly 38 in proximity to the grip portion 44 such that the operator may hold the grip portion 44 and operate the actuator with one hand and hold and move the relatively movable portion (the housing of the motor and/or of the drive mechanism) with the other hand.

In some embodiments, the actuator may be positioned so that it is engageable during cutting operations so that the configuration of the tool 10 is adjustable “on the fly” (not shown). In other embodiments, the actuator may be positioned so that it is not engageable during cutting operations.

The tool 10 may include one or more independent features similar to those disclosed in U.S. Patent Application Ser. No. 60/619,788, filed Oct. 16, 2004, the entire contents of which is hereby incorporated by reference.

In operation, the operator grips the grip portion 44 with one hand, and the handle assembly 38 engages a portion of the operator's hand and arm. The operator's other hand is free to hold the workpiece, hold a guide, support the operator, etc. Alternatively, the operator can grip another portion of the tool 10 (e.g., the gear case 18) with the other hand. The on/off switch 70 is actuated to operate the motor 16, as desired, to cut the workpiece.

The independent aspects and independent embodiments described above and illustrated in the figures are presented by way of example only and are not intended as a limitation upon the concepts and principles of the present invention.

What is claimed is:

1. A reciprocating saw comprising:
a reciprocatable spindle for supporting a saw blade for reciprocating sawing movement;
a body housing a motor and a drive mechanism driven by the motor, the drive mechanism selectively driving the spindle, the body supporting the spindle proximate a forward end and configured to support a battery proximate a rearward end; and
a grip extending outwardly from the body, the grip having a first end coupled to the body, a second end opposite the first end, and a grip axis extending longitudinally through the first and second ends, the grip axis extending through the body such that a center of gravity of the saw is located forwardly of the grip axis when the battery is disconnected from the body and the center of gravity of the saw is located rearwardly of the grip axis when the battery is connected to the body so as to allow an operator to operate the reciprocating saw with a first hand and support a workpiece being cut with a second hand.

2. The reciprocating saw of claim 1, wherein the grip extends outwardly from the body between the forward end and the rearward end.

3. The reciprocating saw of claim 1, wherein the grip extends outwardly from an upper surface of the body.

4. The reciprocating saw of claim 1, wherein the grip provides a first portion of a handle assembly, and wherein a second portion of the handle assembly extends outwardly from the first portion across an upper surface of the body.

5. The reciprocating saw of claim 4, wherein the handle assembly is shaped to cradle an arm of the operator between the upper surface and the second portion.

6. The reciprocating saw of claim 1, wherein the grip is generally D-shaped and at least a portion of the grip is engageable with an arm of the operator during operation of the saw.

7. The reciprocating saw of claim 1, further comprising a switch assembly supportable on the grip and operable to electrically connect the motor to a power source; and
a guard extending across the switch assembly and at least a portion of the grip.

8. The reciprocating saw of claim 1, wherein the grip provides a first portion of a handle assembly, and wherein a second portion of the handle assembly is engageable with an arm of the operator arm while the grip is engageable with the first hand.

9. The reciprocating saw of claim 8, wherein the second portion is a cantilever arm extending away from the grip.

10. The reciprocating saw of claim 1, wherein the body provides a gear case and a motor housing, and wherein the grip extends outwardly from the body adjacent the gear case.

11. A reciprocating saw comprising:
a reciprocatable spindle for supporting a saw blade for reciprocating sawing movement along a spindle axis;
a body housing a motor and a drive mechanism driven by the motor, the drive mechanism selectively driving the spindle, the body supporting the spindle proximate a forward end and configured to support a battery proximate a rearward end, the body supporting the motor substantially between the drive mechanism and the battery; and
a grip extending outwardly from an upper surface of the body between the forward end and the rearward end of the body, the grip having a first end coupled to the body, a second end opposite the first end, and a grip axis extending longitudinally through the first and second ends, the grip being positioned substantially above the spindle axis such that the grip axis extends through the motor between the spindle and the battery.

12. The reciprocating saw of claim 11, wherein the grip extends outwardly from the body proximate a center of gravity of the saw so as to allow an operator to generally balance the saw upon an arm of the operator during use.

13. The reciprocating saw of claim 11, wherein the grip provides a first portion of a handle assembly, and wherein a second portion of the handle assembly extends outwardly from the first portion across an upper surface of the body.

14. The reciprocating saw of claim 13, wherein the handle assembly is shaped to cradle an arm of an operator between the upper surface and the second portion.

15. The reciprocating saw of claim 11, wherein at least a portion of the grip is engageable with an arm of an operator during operation of the saw.

16. The reciprocating saw of claim 11, further comprising
a switch assembly supportable on the grip and operable to electrically connect the motor to a power source; and
a guard extending across at least a portion of the switch assembly and the grip.

17. The reciprocating saw of claim 11, wherein the grip provides a first portion of a handle assembly, and wherein a second portion of the handle assembly is engageable with an arm of an operator while the grip is engageable with a hand of the operator.

18. The reciprocating saw of claim 17, wherein the second portion is a cantilever arm extending away from the grip.

19. The reciprocating saw of claim 11, wherein the body provides a gear case and a motor housing, and wherein the grip extends outwardly from the body adjacent the gear case.

20. The reciprocating saw of claim 11, wherein, when the battery is supported by the body, the battery is operable to supply power to the motor, and wherein the grip extends outwardly from the body proximate a center of gravity of the saw and the battery.
